(19) United States
(12) Patent Application Publication
(10) Pub. No.: US 2025/0164960 A1
(43) Pub. Date: May 22, 2025

(54) CONTROL DEVICE AND CONTROL METHOD

(71) Applicant: MITSUBISHI HEAVY INDUSTRIES, LTD., Tokyo (JP)

(72) Inventor: Akira Nishiyama, Tokyo (JP)

(73) Assignee: MITSUBISHI HEAVY INDUSTRIES, LTD., Tokyo (JP)

(21) Appl. No.: 18/839,551

(22) PCT Filed: Feb. 16, 2023
(86) PCT No.: PCT/JP2023/005434

§ 371 Date: Aug. 19, 2024

(30) Foreign Application Priority Data
Feb. 28, 2022 (JP) 2022-029726

(51) Int. Cl. G05B 19/05

(52) U.S. Cl. CPC G05B 19/058; G05B 2219/14112

(57) ABSTRACT

The control device includes a processor that repeatedly executes a calculation process for controlling an apparatus based on circuit information read from a circuit information memory, a data memory that sequentially stores calculation results of the calculation process, and a diagnosis unit that executes a diagnosis process for diagnosing presence or absence of a bit error in the circuit information stored in the circuit information memory. In a case where the bit error is diagnosed by the diagnosis unit, the processor outputs, as the calculation result, recent past data corresponding to a case where no bit error is diagnosed by the diagnosis unit, among the calculation results stored in the data memory, or alternative data prepared in advance to correspond to the past data.

### TECHNICAL FIELD

The present disclosure relates to a control device and a control method.

The present application claims priority based on Japanese Patent Application No. 2022-029726 filed in Japan on Feb. 28, 2022, the contents of which are incorporated herein by reference.

### BACKGROUND ART

As a device capable of reconfiguring an internal logic circuit design based on circuit information, a programmable logic device (PLD) is known. Circuit information is prepared in advance in an external storage medium such as a memory (circuit information memory), and a logic circuit for implementing a specific function based on the circuit information is configured by the processor of the programmable logic device incorporating the circuit information.

Circuit information for configuring a logic circuit inside the programmable logic device is incorporated from the outside (for example, a circuit information memory or the like) by the processor, but a bit error may occur in the circuit information due to a factor such as neutrons falling on the surface of the earth, for example. The bit error in the circuit information may cause an error in the logic circuit configured in the processor based on the circuit information. In a case where a programmable logic device is used as a control device requiring control accuracy, the error in the logic circuit becomes a factor causing malfunction or trouble in an apparatus to be controlled. Therefore, a diagnosis process for diagnosing the presence or absence of a bit error in the circuit information is known (for example, PTL 1).

### CITATION LIST

### Patent Literature

[PTL 1] PCT Japanese Translation Patent Publication No. 2006-523350

### SUMMARY OF INVENTION

### Technical Problem

In the above-described diagnosis process, it is possible to diagnose the presence or absence of a bit error in the circuit information. However, since the processor outputs the calculation result by the logic circuit configured based on the circuit information regardless of the presence or absence of the bit error in the circuit information, in a case where the bit error is diagnosed, the calculation result by the process having low reliability is output (that is, there is a possibility that the calculation result, which is an error by the process having low reliability, will flow out). In order to avoid such a situation, it is conceivable to prepare a plurality of the same programmable logic devices and to output a calculation result in which reliability is ensured by majority voting. However, the scale of a configuration is increased and the cost is increased.

At least one embodiment of the present disclosure has been made in view of the above circumstances, and an object of the present disclosure is to provide a control device and a control method capable of suitably maintaining the reliability of a calculation result even in a case where a bit error occurs in circuit information while suppressing an increase in the complexity of the configuration.

### Solution to Problem

In order to solve the above problems, a control device according to at least one embodiment of the present disclosure includes:
a circuit information memory that stores circuit information;
a processor that repeatedly executes a calculation process for controlling an apparatus based on the circuit information read from the circuit information memory;
a data memory that sequentially stores calculation results of the calculation process; and
a diagnosis unit that executes a diagnosis process for diagnosing presence or absence of a bit error in the circuit information stored in the circuit information memory, in which
the processor is configured to output, as the calculation result, recent past data corresponding to a case where no bit error is diagnosed by the diagnosis unit, among the calculation results stored in the data memory, or alternative data prepared in advance to correspond to the past data, in a case where the bit error is diagnosed by the diagnosis unit.

A control method according to at least one embodiment of the present disclosure is a control method using a control device including
a circuit information memory that stores circuit information,
a processor that repeatedly executes a calculation process for controlling an apparatus based on the circuit information read from the circuit information memory, a data memory that sequentially stores calculation results of the calculation process, and
a diagnosis unit that executes a diagnosis process for diagnosing presence or absence of a bit error in the circuit information stored in the circuit information memory, the method including:
outputting, as the calculation result of the processor, recent past data corresponding to a case where no bit error is diagnosed by the diagnosis unit, among the calculation results stored in the data memory, or alternative data prepared in advance to correspond to the past data, in a case where the bit error is diagnosed by the diagnosis unit.

### Advantageous Effects of Invention

According to at least one embodiment of the present disclosure, it is possible to provide a control device and a control method capable of suitably maintaining the reliability of the calculation result even in a case where a bit error occurs in circuit information while suppressing an increase in the complexity of the configuration.

### BRIEF DESCRIPTION OF DRAWINGS

FIG. 1 is a block diagram showing an internal configuration of a control device according to an embodiment.

FIG. 2 is a flowchart showing a control method according to the embodiment.

FIG. 3 is a time chart showing processing cycles of a processor, a data memory, and a scrubbing module of FIG. 1 in parallel.

### DESCRIPTION OF EMBODIMENTS

Hereinafter, some embodiments of the present invention will be described with reference to the accompanying drawings. Meanwhile, configurations described in the embodiments or illustrated in the drawings are not intended to limit the scope of the invention, and are merely examples for description.

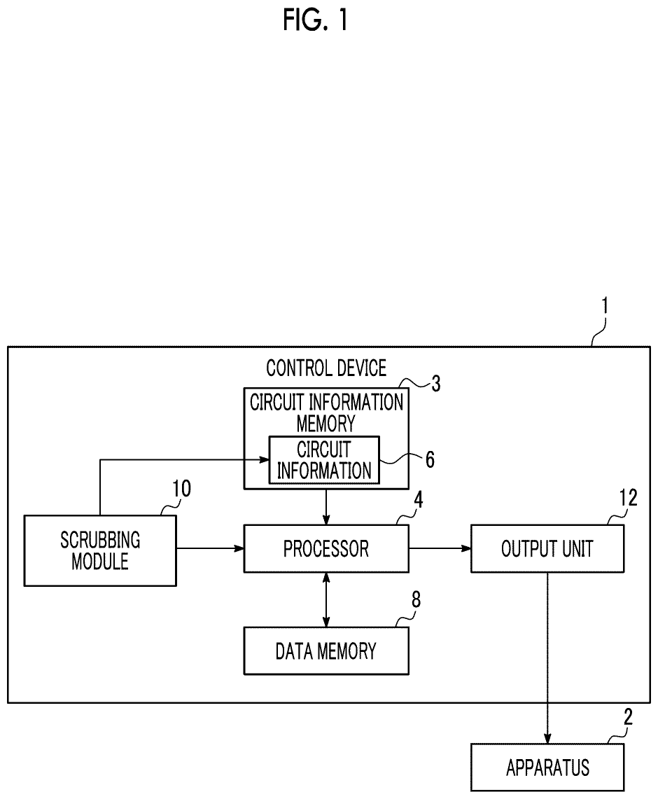

FIG. 1 is a block diagram showing an internal configuration of a control device 1 according to an embodiment. The control device 1 is a device for controlling an apparatus 2 and is configured as a programmable logic device (PLD). The control device 1, which is a programmable logic device, implements a calculation process for obtaining a calculation result including a control parameter for the apparatus 2 to be controlled, via a logic circuit configured inside the control device 1 based on circuit information 6.

The hardware configuration of the control device 1 is the same as that of a known programmable logic device, and details thereof will be omitted.

The control device 1 includes a circuit information memory 3, a processor 4, a data memory 8, a scrubbing module 10, and an output unit 12.

The circuit information memory 3 is configured to store the circuit information 6. The circuit information 6 is information for configuring a logic circuit for implementing a predetermined calculation process by being incorporated into the processor 4.

The processor 4 is configured to access the circuit information memory 3 and acquire the circuit information 6 stored in the circuit information memory 3 to repeatedly execute the calculation process corresponding to the circuit information 6.

The data memory 8 is configured to store various types of information necessary for the calculation process of the processor 4 and the calculation result of the processor 4. For example, the processor 4 in which the logic circuit corresponding to the circuit information 6 is configured as described above acquires information necessary for the calculation process using the logic circuit from the data memory 8 by accessing the data memory 8. Then, the processor 4 performs the calculation process using the logic circuit, and the calculation result is stored in the data memory 8. The calculation result stored in the data memory 8 can be appropriately retrieved and can also be appropriately discarded.

In the present embodiment, at least a part of various types of information stored in the data memory 8 may be stored in, for example, a storage device such as an external memory outside the control device 1. However, as in the present embodiment, the various types of information are stored in the data memory 8, which is the internal configuration of the control device 1, so that the time required for exchanging the various types of information between the processor 4 and the data memory 8 is shortened, and the control device 1 having a good operation speed can be implemented.

The scrubbing module 10 is configured to perform a scrubbing process on the circuit information 6 stored in the circuit information memory 3. The scrubbing module 10 is an aspect of the diagnosis unit that executes the diagnosis process for diagnosing the presence or absence of a bit error in the circuit information 6, and is a module for executing the scrubbing process for correcting the bit error in a case where the bit error is diagnosed via the diagnosis process. As described above, the circuit information 6 is stored in advance in the circuit information memory 3 in a retrievable manner as information for configuring a logic circuit for performing a predetermined calculation process by the processor 4. In the circuit information 6 stored in the circuit information memory 3 in this way, a bit error may occur due to various factors (for example, neutrons falling on the surface of the earth). Since the bit error in the circuit information 6 is a factor that causes an error in the logic circuit configured in the processor 4 when the circuit information 6 is retrieved by the processor 4, the scrubbing module 10 diagnoses the presence or absence of the bit error in the circuit information 6 by performing a scrubbing process on the circuit information 6 stored on the circuit information memory 3. Notification of the diagnosis result of the bit error by the scrubbing module 10 is sent to the processor 4.

The output unit 12 is configured to output a control parameter based on a calculation result of the control device 1, to a control target of the control device 1. The control parameter output from the output unit 12 is variable based on the diagnosis result of the scrubbing module 10. As will be described in detail later, in a case where the scrubbing module 10 diagnoses that no bit error is present in the circuit information 6, the logic circuit configured in the processor 4 by the circuit information 6 has sufficient reliability. Therefore, the calculation result of the processor 4 is output from the output unit 12 to the apparatus 2 as the control parameter. On the other hand, in a case where the scrubbing module 10 diagnoses that a bit error is present in the circuit information 6, the reliability of the logic circuit configured in the processor 4 based on the circuit information 6 is reduced. Therefore, the calculation result of the processor 4 is not output from the output unit 12 (that is, the calculation result having low reliability does not flow out to the outside of the control device 1), and recent past data or alternative data is output as the control parameter.

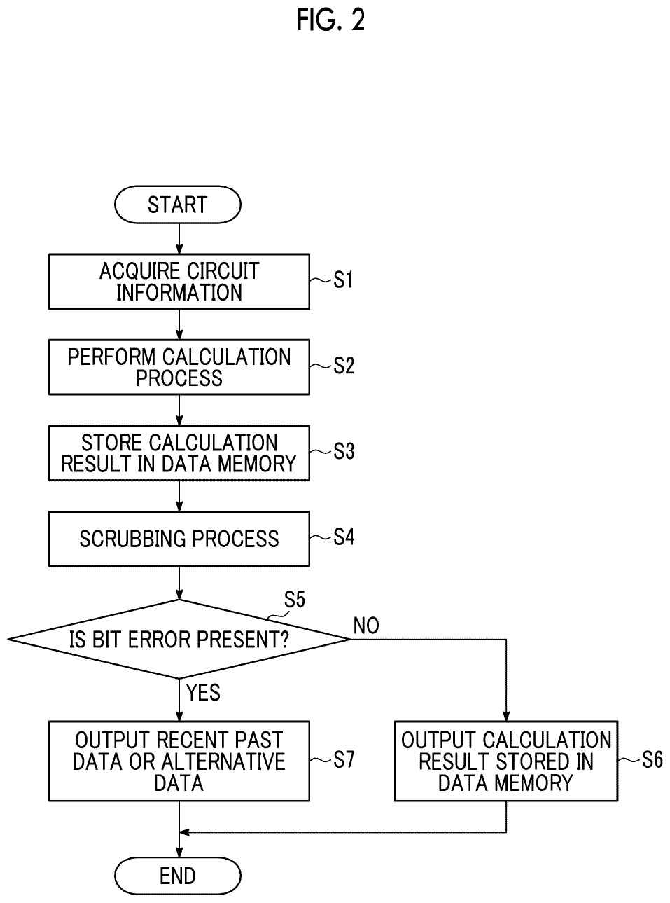

Next, a control method performed by the control device 1 having the above configuration will be described. FIG. 2 is a flowchart showing a control method according to the embodiment.

The processor 4 acquires the circuit information 6 (step S1). The circuit information 6 is prepared in the circuit information memory 3 such that a logic circuit corresponding to a predetermined calculation process is configured in the processor 4, and the processor 4 acquires the circuit information 6 stored in advance in the circuit information memory 3 by accessing the circuit information memory 3. A logic circuit corresponding to the acquired circuit information 6 is constructed in the processor 4 in this manner, and the calculation process can be performed.

Subsequently, the processor 4 performs the calculation process corresponding to the circuit information 6 acquired in step S1 (step S2). In step S2, the calculation process using the logic circuit constructed by the circuit information 6 may be performed, and various types of information necessary for the calculation process may be incorporated. In the present embodiment, data necessary for the calculation process corresponding to the circuit information 6 is stored in the data memory 8 in advance, and the processor 4 can acquire the data by accessing the data memory 8.

The acquisition destination of the data necessary for the calculation process in step S2 is not limited to the data memory 8, and the data may be acquired from another memory included in the control device 1 or an external memory attached to the control device 1.

Subsequently, the processor 4 stores the calculation result obtained by the calculation process of step S2 in the data memory 8 (step S3). That is, in step S3, the calculation result obtained by the processor 4 is not transmitted to the output unit 12 as it is, and is temporarily stored in the data memory 8. Accordingly, due to the scrubbing process, the calculation result is prevented from flowing out from the output unit 12 as it is, in a case where the reliability of the calculation result is low.

Subsequently, the scrubbing module 10 performs the scrubbing process on the circuit information 6 stored in the circuit information memory 3 (step S4). In the scrubbing process, the presence or absence of a bit error in the circuit information 6 stored in the circuit information memory 3 is diagnosed, and the error is corrected in a case where the error is present. The calculation process of the processor 4 is performed based on the circuit information 6 acquired in step S1. However, in step S4, the scrubbing module 10 accesses the circuit information memory 3, which is an acquisition destination of the circuit information 6, to diagnose the presence or absence of a bit error in the circuit information 6.

Further, notification of the diagnosis result of the scrubbing process in step S4 is sent from the scrubbing module 10 to the processor 4.

Subsequently, the processor 4 determines whether or not a bit error is present in the circuit information 6 via the scrubbing process of step S4, based on the notification from the scrubbing module 10 (step S5). In a case where it is determined that no bit error is present in the circuit information 6 (step S5: NO), the processor 4 determines that a correct logic circuit is configured by the circuit information 6 and the calculation result thereof is also sufficiently reliable, and outputs the calculation result stored in the data memory 8 in step S3 from the output unit 12 (step S6). By outputting the calculation result based on the circuit information 6 in which it is confirmed that no bit error is present via the scrubbing process, good control accuracy is obtained.

On the other hand, in a case where it is determined that a bit error is present in the circuit information 6 (step S5: YES), the processor 4 outputs the recent data (hereinafter, referred to as “recent past data” as appropriate), among the past calculation results obtained based on the circuit information 6 in which it is determined that no bit error is present, or alternative data, as the calculation result from the output unit 12 (step S7). In this case, since the calculation process of the processor 4 performed in step S2 is performed based on the circuit information 6 in which the bit error is present, the calculation result obtained based on the circuit information 6 (the calculation result stored in the data memory 8 in step S3) has low reliability. Therefore, in step S7, the recent past data or alternative data is output instead of the calculation result obtained in step S2 (the calculation result stored in the data memory 8 in step S3), so that the calculation result having low reliability is prevented from flowing out from the output unit 12 to the apparatus 2.

In a case where a bit error in the circuit information 6 is diagnosed via the scrubbing process, the calculation result stored in the data memory 8 in step S3 may be discarded. That is, in step S3, the calculation result of the processor 4 is temporarily stored in the data memory 8, and in a case where a bit error in the circuit information 6 is diagnosed via the scrubbing process, the temporarily stored calculation result is discarded. Accordingly, the reliability can be suitably ensured by preventing the calculation result having low reliability from remaining in the data memory 8, and the capacity of the data memory 8 can be effectively saved.

The recent past data handled in step S7 is acquired, for example, by sequentially storing the past calculation process in the data memory 8 in step S3, for each cycle in which the processor 4 repeats the calculation process of step S2, and searching for the recent data among pieces of data in which it is determined that no bit error is present in the circuit information 6 via the scrubbing process of step S5. In this case, the processing time of the processor 4 and the diagnosis result of the scrubbing module 10 are stored in the data memory 8 in association with each calculation result. Accordingly, the processor 4 can suitably specify the recent past data corresponding to a case where no bit error is diagnosed by the scrubbing module, by searching for the past calculation results accumulated in the data memory 8.

The alternative data handled in step S7 is prepared in advance as various types of data having higher reliability than the calculation result based on the circuit information 6 diagnosed to have a bit error via the scrubbing process. For example, the alternative data may be past data, or may be a simulation result obtained as a preferred value suitable for the apparatus 2.

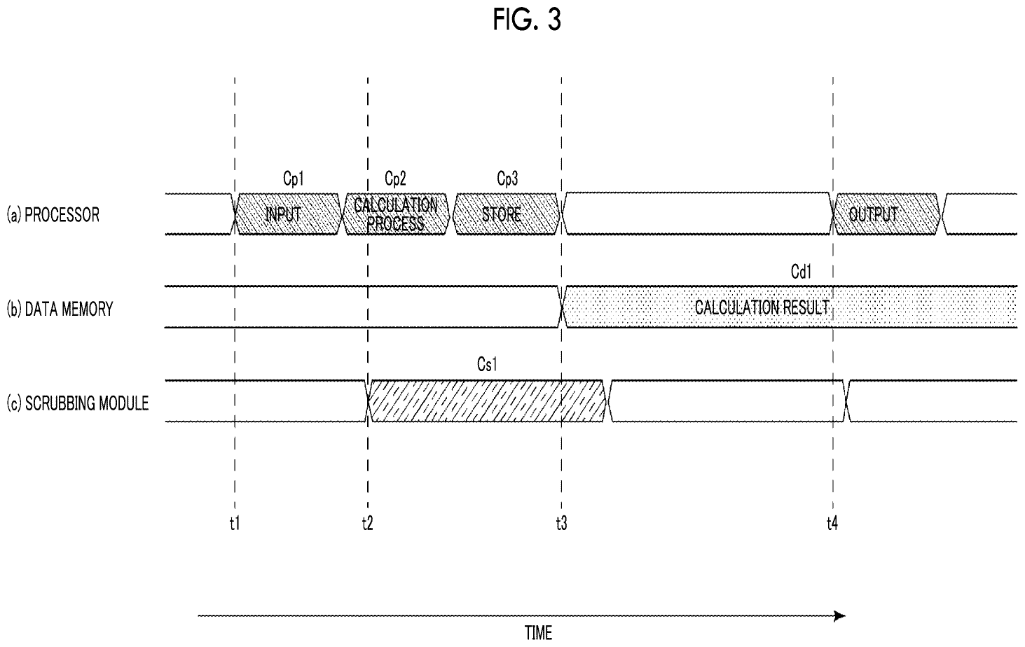

In FIG. 2, for convenience of description, the scrubbing process in step S4 is shown to be performed after steps S2 and S3. However, the scrubbing process in step S4 may be performed in parallel with the calculation process of the processor 4 in step S2. FIG. 3 is a time chart showing processing cycles of the processor 4, the data memory 8, and the scrubbing module 10 of FIG. 1 in parallel. FIG. 3 shows a state where a processing cycle is repeated for each of the processor 4, the data memory 8, and the scrubbing module 10.

FIG. 3 shows a case in which the processing cycles of the processor 4, the data memory 8, and the scrubbing module 10 have different time widths from each other. However, the same time width may be used. In addition, FIG. 3 shows each processing cycle of each configuration related to a series of calculation processes in hatching to emphasize the processing cycle, and other processing cycles without hatching are used for other calculation processes.

In this example, in the processor 4, the calculation process performed in step S2 of FIG. 2 is performed over three processing cycles Cp1 to Cp3 from a time t1. In the first processing cycle Cp1, various types of information necessary for the calculation process in the logic circuit of the processor 4 configured based on the circuit information 6 are input from the data memory 8. In the second processing cycle Cp2, the various types of information input in the first processing cycle Cp1 are applied to the logic circuit to execute the calculation process. In the third processing cycle Cp3, the calculation result obtained in the second processing cycle Cp2 is stored in the data memory 8 (the third processing cycle Cp3 corresponds to step S3 in FIG. 2). In response to this, in the data memory 8, the calculation result obtained by the processor 4 is stored at a time t3 when the calculation process by the processor 4 is completed (in the processing cycle Cd1).

In parallel with the calculation process of the processor 4, the scrubbing module 10 performs a scrubbing process on the circuit information 6 on the circuit information memory 3, which is the basis of the calculation process of the processor 4. The scrubbing process is performed in a processing cycle Cs1 that starts from a time t2, which is during a period (times t1 to t3) in which the calculation process is performed by the processor 4. When the scrubbing process is completed, notification of the diagnosis result of the scrubbing process is sent to the processor 4, and the processor 4 outputs an appropriate calculation result from the data memory 8 (in a case where the diagnosis result indicating that no bit error is present in the circuit information 6 via the scrubbing process is obtained, the calculation result stored in the data memory 8 is output from the output unit 12 as it is. On the other hand, in a case where the diagnosis result indicating that a bit error is present in the circuit information 6 is obtained via the scrubbing process, the recent past data or the alternative data is output from the output unit 12 as the calculation result as described above, instead of the calculation result stored in the data memory 8).

In a case where the diagnosis result indicating that a bit error is present is obtained a plurality of times in succession by the scrubbing module 10 (in a case where the diagnosis result indicating that a bit error is present is obtained over a plurality of consecutive processing cycles of the scrubbing module 10), in step S7, the processor 4 may output the alternative data from the output unit 12 as the calculation result. Accordingly, even in a case where a time during which a highly reliable calculation result is not obtained by the processor 4 continues due to consecutive occurrences of unfavorable diagnosis results (diagnosis results indicating that a bit error is present) by the scrubbing module 10, the reliability can be suitably ensured by outputting a value suitable for the calculation result as the alternative data. In this case, a simulation result obtained by simulating the behavior of the apparatus 2 can be used as the alternative data.

As described above, according to each of the above embodiments, in a case where a bit error in the circuit information 6 on the circuit information memory 3 is diagnosed via the scrubbing process, data having reliability such as the recent past data of the calculation result or the alternative data is output to the apparatus 2. Accordingly, a case where a calculation result having low reliability based on the logic circuit constructed by the circuit information 6 in which a bit error is present is output to the apparatus 2 is avoided, and good control accuracy is obtained even in a case where a bit error is present in the circuit information 6. Furthermore, in such a configuration, the reliability of the output can be ensured in a single processor 4. Therefore, the configuration is simple, and the cost can be reduced as compared with a case where the reliability is ensured by majority voting by providing equivalent configurations in parallel.

In addition, it is possible to appropriately replace the components in the embodiment described above with well-known components within the scope which does not depart from the concept of the present disclosure, and the embodiments described above may be appropriately combined with each other.

For example, contents described in each of the above-described embodiments are understood as follows.

(1) A control device (1) according to one aspect includes:
a circuit information memory (3) that stores circuit information (6);
a processor (4) that repeatedly executes a calculation process for controlling an apparatus (2) based on the circuit information read from the circuit information memory;
a data memory (8) that sequentially stores calculation results of the calculation process; and
a diagnosis unit (10) that executes a diagnosis process for diagnosing presence or absence of a bit error in the circuit information stored in the circuit information memory, in which the processor is configured to output, as the calculation result, recent past data corresponding to a case where no bit error is diagnosed by the diagnosis unit, among the calculation results stored in the data memory, or alternative data prepared in advance to correspond to the past data, in a case where the bit error is diagnosed by the diagnosis unit.

According to the aspect of the above (1), in a case where a bit error in the circuit information on the circuit information memory is diagnosed via the scrubbing process, data in which reliability is ensured, such as the recent past data of the calculation result of the alternative data, is output. Accordingly, it is possible to avoid an output of a calculation result having low reliability based on the logic circuit generated by the circuit information in which a bit error is present, and it is possible to suitably ensure the reliability of the calculation result output from the processor even in a case where a bit error is present in the circuit information. In this manner, in the present aspect, the reliability of the output can be ensured in a single processor. Therefore, the configuration is simple, and the cost can be reduced as compared with a case where the reliability is ensured by majority voting by providing equivalent configurations in parallel.

(2) In another aspect, in the aspect of the above (1),
the diagnosis unit is a scrubbing module that performs a scrubbing process for correcting the bit error, in a case where the bit error is diagnosed via the diagnosis process.

According to the aspect of the above (2), as the diagnosis unit, the scrubbing module that performs the scrubbing process for correcting the bit error in a case where a bit error is diagnosed can be suitably applied to the control device.

(3) In another aspect, in the aspect of the above (1) or (2),
the processor r temporarily stores the calculation result in the data memory, and discards the calculation result from the data memory, in a case where the bit error is diagnosed by the diagnosis unit.

According to the aspect of the above (3), the calculation result of the processor is temporarily stored in the data memory. However, in a case where a bit error in the circuit information is diagnosed via the diagnosis process, the calculation result based on the circuit information is discarded. Accordingly, the reliability can be suitably ensured by preventing the calculation result having low reliability from remaining in the data memory, and the capacity of the data memory can be saved.

(4) In another aspect, in the aspect of any one of the above (1) to (3),
the processor is configured to acquire the past data from the data memory.

According to the aspect of the above (4), the past data is acquired from the data memory which is the internal configuration of the control device. Therefore, a good operation speed can be obtained as compared with a case where the past data is acquired from the external configuration of the control device.

(5) In another aspect, in the aspect of any one of the above (1) to (4),
the diagnosis process is executed in parallel with the calculation process by the processor.

According to the aspect of the above (5), the calculation process of the processor and the diagnosis process of the diagnosis unit are executed in parallel with each other, so that a good operation speed can be obtained.

(6) In another aspect, in the aspect of any one of the above (1) to (5),
the processing time of the processor and the diagnosis result of the diagnosis unit are stored in the data memory in association with each other for each of the calculation results.

According to the aspect of the above (6), the calculation result of the processor is stored in the data memory in a state associated with the processing time of the processor and the diagnosis result of the diagnosis process. Accordingly, the processor can suitably specify the recent past data corresponding to a case where no bit error is diagnosed by the diagnosis unit by searching for the past calculation result accumulated in the data memory.

(7) In another aspect, in the aspect of any one of the above (1) to (6),
in a case where a diagnosis result indicating that the bit error is present is obtained a plurality of times in succession by the diagnosis unit, the processor outputs the alternative data as the calculation result.

According to the aspect of the above (7), in a case where a diagnosis result indicating that a bit error is present is obtained a plurality of times in succession by the repeatedly executed diagnosis process, the processor outputs the alternative data prepared in advance as the calculation result. Accordingly, even in a case where a time during which a highly reliable calculation result is not obtained continues due to consecutive occurrences of unfavorable diagnosis results (diagnosis results indicating that a bit error is present), the reliability can be suitably ensured by outputting a desired value as the calculation result.

(8) In another aspect, in the aspect of any one of the above (1) to (7),
the alternative data is a simulation result related to the calculation result.

According to the aspect of the above (8), the simulation is performed in advance on the calculation result of the processor suitable for the apparatus to be controlled, and the simulation result is output as the calculation result. In this manner, even in a case where a bit error occurs in the circuit information, the calculation result of the processor can be set to an appropriate desired value, and reliability can be suitably ensured.

(9) A control method according to one aspect is a control method using a control device including
a circuit information memory (3) that stores circuit information (6),
a processor (4) that repeatedly executes a calculation process for controlling an apparatus (2) based on the circuit information read from the circuit information memory,
a data memory (8) that sequentially stores calculation results of the calculation process, and
a diagnosis unit (10) that executes a diagnosis process for diagnosing presence or absence of a bit error in the circuit information stored in the circuit information memory, the method including:
outputting, as calculation result of the the processor, recent past data corresponding to a case where no bit error is diagnosed by the diagnosis unit, among the calculation results stored in the data memory, or alternative data prepared in advance to correspond to the past data, in a case where the bit error is diagnosed by the diagnosis unit.

According to the aspect of the above (9), in a case where a bit error in the circuit information on the circuit information memory is diagnosed via the diagnosis process, data having ensured reliability, such as the recent past data of the calculation: result or the alternative data, is output. Accordingly, it is possible to avoid an output of a calculation result having low reliability based on the logic circuit generated by the circuit information in which a bit error is present, and it is possible to suitably ensure the reliability of the calculation result output from the processor even in a case where a bit error is present in the circuit information. In this manner, in the present aspect, the reliability of the output can be ensured in a single processor. Therefore, the configuration is simple, and the cost can be reduced as compared with a case where the reliability is ensured by majority voting by providing equivalent configurations in parallel.

### REFERENCE SIGNS LIST

1 control device
2 apparatus
3 circuit information memory
4 processor
6 circuit information
8 data memory
10 scrubbing module
12 output unit

1. A control device comprising:
a circuit information memory that stores circuit information;
a processor that repeatedly executes a calculation process for controlling an apparatus based on the circuit information read from the circuit information memory;
a data memory that sequentially stores calculation results of the calculation process; and
a diagnosis unit that executes a diagnosis process for diagnosing presence or absence of a bit error in the circuit information stored in the circuit information memory, wherein
the processor is configured to output, as the calculation result, recent past data corresponding to a case where no bit error is diagnosed by the diagnosis unit, among the calculation results stored in the data memory, or
alternative data prepared in advance to correspond to the past data, in a case where the bit error is diagnosed by the diagnosis unit.

2. The control device according to claim 1, wherein
the diagnosis unit is a scrubbing module that performs a scrubbing process for correcting the bit error, in a case where the bit error is diagnosed via the diagnosis process.

3. The control device according to claim 1, wherein
the processor temporarily stores the calculation result in the data memory,
and discards the calculation result from the data memory, in a case where the bit error is diagnosed by the diagnosis unit.

4. The control device according to claim 1, wherein
the processor is configured to acquire the past data from the data memory.

5. The control device according to claim 1, wherein
the diagnosis process is executed in parallel with the calculation process by the processor.

6. The control device according to claim 1, wherein
a processing time of the processor and a diagnosis result of the diagnosis unit are stored in the data memory in association with each other for each of the calculation results.

7. The control device according to claim 1, wherein
in a case where a diagnosis result indicating that the bit error is present is obtained a plurality of times in succession by the diagnosis unit, the processor outputs the alternative data as the calculation result.

8. The control device according to claim 1, wherein
the alternative data is a simulation result related to the calculation result.

9. A control method using a control device including
a circuit information memory that stores circuit information,
a processor that repeatedly executes a calculation process for controlling an apparatus based on the circuit information read from the circuit information memory,
a data memory that sequentially stores calculation results of the calculation process, and
a diagnosis unit that executes a diagnosis process for diagnosing presence or absence of a bit error in the circuit information stored in the circuit information memory, the method comprising:
outputting, as the calculation result of the processor, recent past data corresponding to a case where no bit error is diagnosed by the diagnosis unit, among the calculation results stored in the data memory, or
alternative data prepared in advance to correspond to the past data, in a case where the bit error is diagnosed by the diagnosis unit.
